(19) United States
(12) Patent Application Publication
(10) Pub. No.: US 2011/0012446 A1
(43) Pub. Date: Jan. 20, 2011

(54) ELECTRIC POWER TOOL

(76) Inventors: Joerg Maute, Sindelfingen (DE); Florian Esenwein, Uhingen-Holzhausen (DE); Albrecht Hofmann, Steinenbronn (DE); Thomas Schomisch, Filderstadt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/934,410

(22) PCT Filed: Dec. 18, 2008
(86) PCT No.: PCT/EP08/67879

§ 371 Date: Sep. 24, 2010

(30) Foreign Application Priority Data
Mar. 26, 2008 (DE) 10 2008 000 828.1

(51) Int. Cl. H02K 7/14

(52) U.S. Cl. 310/50

(57) ABSTRACT

In an electric machine tool with a commutator motor which has a motor shaft which is arranged rotatably in a motor housing and has a commutator, at least two commutator brushes are assigned which are accessible via at least one brush cover provided on the motor housing. A covering element fixes the brush cover on the motor housing in an operating position in which the commutator brushes are covered. The covering element in turn is fastened on the motor housing via a detachable connection.

### PRIOR ART

The present invention relates to an electric power tool with a commutator motor that has a motor shaft, which is supported in rotary fashion in a motor housing and is equipped with a commutator that is associated with at least two commutator brushes that are accessible via at least one brush cover provided on the motor housing.

DE 36 35 067 A1 describes an electric power tool of this kind. It has two commutator brushes situated diametrically opposite each other on the commutator, which are guided in an axially movable fashion in associated brush holders. Each brush holder is accessible by means of a housing opening provided on the motor housing, each of which is provided with a brush cover. In an operating position of the brush covers, each brush cover is closed by means of an associated screw connection to the motor housing so that the commutator brushes are covered. To carry out a brush replacement, the screw connections of the brush covers must be detached in order to open or remove the covers, thus permitting access to the brushes.

In the prior art, it is disadvantageous that with electric power tools of this kind, the brush covers are fastened to the motor housing by means of screw connections and for each screw connection, a corresponding screw boss must be provided in or on the motor housing. This leads to space problems due to the respectively available installation space as the power density and compactness of conventional electric power tools steadily rise. In addition when replacing brushes, a respective screw connection must be detached for each commutator brush to be replaced, which makes brush replacement complicated and expensive.

### DISCLOSURE OF THE INVENTION

One object of the invention, therefore, is to create a new electric power tool and a new brush cover that permit simple, reliable, quick access to the commutator brushes of the electric power tool.

This object is attained by means of an electric power tool with a commutator motor that has a motor shaft, which is supported in rotary fashion in a motor housing and is equipped with a commutator. The commutator is associated with at least two commutator brushes that are accessible via at least one brush cover provided on the motor housing. A cover element affixes the brush cover to the motor housing in an operating position in which the commutator brushes are covered. The cover element is fastened to the motor housing by means of a detachable connection.

The invention consequently permits quick, simple opening and closing of the brush covers through detachment and reattachment of a detachable connection between the cover element and the motor housing.

Preferably, the electric power tool is provided with a spring element that serves to prestress the brush cover in the direction toward a maintenance position that permits access to the commutator brushes.

Consequently, the brush cover opens automatically upon detachment of the detachable connection between the cover element and the motor housing.

According to one embodiment, the cover element is a cup-shaped housing cover that at least partially encompasses the motor housing. In this case, the brush cover is preferably affixed to the motor housing in the operating position by means of a form-locked engagement between the cover element and a first end region of the brush cover.

The invention consequently permits a space-saving implementation of the brush cover by omitting a conventional screw connection for affixing the brush cover in place.

The motor housing preferably has an engaging element in which a second end region of the brush cover detachably engages. Alternatively, the brush cover is fastened to the motor housing in pivoting fashion in the second end region.

It is thus possible to effectively prevent the brush cover from inadvertently slipping out of the motor housing upon detachment of the detachable connection between the cover element and the motor housing.

According to one embodiment, the cover element has at least one holding element that engages in a holding device provided on the motor housing. The holding element and holding device form an end stop, which, upon detachment of the detachable connection between the cover element and the motor housing, limits a movement of the cover element intended to release the brush cover.

It is thus possible to effectively prevent an inadvertent removal of the cover element from the electric power tool upon detachment of the detachable connection between the cover element and the motor housing.

The electric power tool is preferably provided with a spring element that prestresses the cover element in the direction toward the end stop.

This facilitates a sliding of the cover element in order to release the brush cover.

According to one embodiment, the holding element has at least one detent lug and the holding device is embodied in the form of a collar-shaped stop.

The holding element and the holding device can therefore be implemented in a simple way.

The object mentioned at the beginning is also attained by means of a brush cover for an electric power tool with a commutator that has a motor shaft, which is supported in rotary fashion in a motor housing and is equipped with a commutator that is associated with at least two commutator brushes. At least one of the commutator brushes is accessible via the brush cover. A cover element can affix the brush cover to the motor housing in an operating position in which the at least one commutator brush is covered. The cover element can be fastened to the motor housing by means of a detachable connection.

### BRIEF DESCRIPTION OF THE DRAWINGS

The invention will be explained in detail in the subsequent description in conjunction with an exemplary embodiment shown in the drawings.

FIG. 1 is a perspective, exploded view of an angle grinder according to the invention;

FIG. 2 is a sectional view of a detail of the angle grinder from FIG. 1;

FIG. 3 is a sectional view of the detail of the angle grinder from FIG. 2 upon detachment of the detachable connection between the cover element and the motor housing;

FIG. 4 is a sectional view of the detail of the angle grinder from FIG. 2 as the brush cover is being opened; and

FIG. 5 is a sectional view of the detail of the angle grinder from FIG. 2 as the brush is being replaced.

### DESCRIPTION OF THE EXEMPLARY EMBODIMENTS

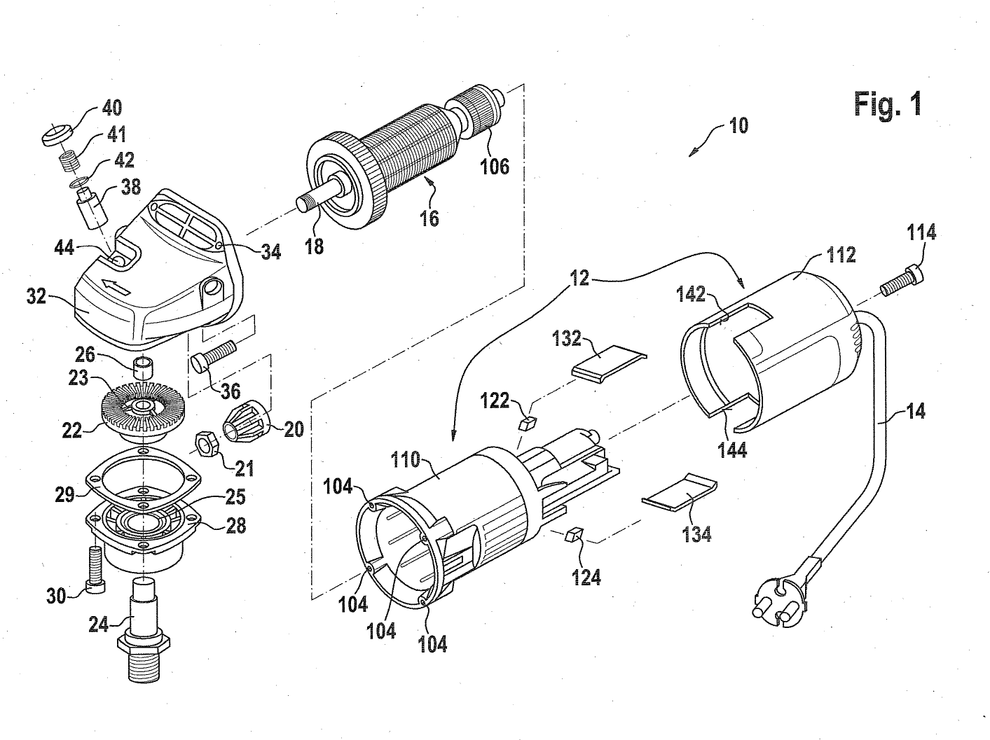

FIG. 1 shows an angle grinder 10 embodied in a cup design, with an elongated cup-shaped housing 12 according to one embodiment of the invention. Among other things, the housing 12 can have a rotor 16 with a motor shaft 18 inserted into it, onto which a bevel gear 20 can be axially mounted by means of a nut 21. The bevel gear 20 is provided to mesh with the gearing of a ring gear 22 whose gearing side is provided with stop recesses 23 embodied in the form of embossed indentations.

The ring gear 22 is supported for co-rotation on a drive shaft 24 that extends at right angles to the motor shaft 18. An axial end region of the drive shaft 24 is encompassed by a bearing sleeve 26 that is situated in an associated bearing eye of a transmission housing 32. Its other axial end region is supported in a ball bearing 25 that is seated in a bearing flange 28. This bearing flange is screw-mounted by means of flange screws 30 to the underside of the transmission housing 32; between the transmission housing 32 and the bearing flange 28, a spacer disk for the transmission plate 29 is provided.

An obliquely guided locking pin 38 is situated in the transmission housing 32 and is connected to an actuating knob 40 that is prestressed by means of a compression spring 41. The locking pin 38 is guided in an axially adjustable, resilient fashion in a spindle lock bore of the transmission housing 32 and can be secured in captive fashion by means of an O-ring 42, for example. When the actuating knob 40 is actuated, the locking pin 38 is slid toward the ring gear 22 and engages in its stop recesses 23, thus locking the ring gear 22 in a rotationally fixed fashion.

The transmission housing 32 can be attached to the housing 12 by means of motor flange screws 36. The screws 36 pass through corresponding flange screw bores 34 with flange screw eyes of the transmission housing 32 and engage in associated screw holes 104 of the housing 12.

According to one embodiment of the invention, the elongated, cup-shaped housing 12 of the angle grinder 10 is composed of two parts and has a housing element 110 and a cover element 112. The housing element 110 encloses the motor of the angle grinder 10 at least partially and therefore is also referred to as the motor housing in the context of the present invention. The cover element 112 is preferably a cup-shaped housing cover with an electrical connector cable 14 leading from its closed end. The cup-shaped housing cover 112 can be slid onto the motor housing 110 in order to at least partially encompass it. In this case, the cover 112 can be detachably fastened to the motor housing 110 by means of a fastening screw 114.

On the outer circumference of the housing cover 112, cut-outs 142, 144 are provided, which are provided to at least partially accommodate brush covers 132, 134. These brush covers serve to cover commutator brushes 122, 124 that cooperate with a commutator 106 situated on the rotor 16 during operation of the angle grinder 10. A detailed description of the angle grinder 10 with the commutator 106 is not given here since its function is sufficiently known from the prior art.

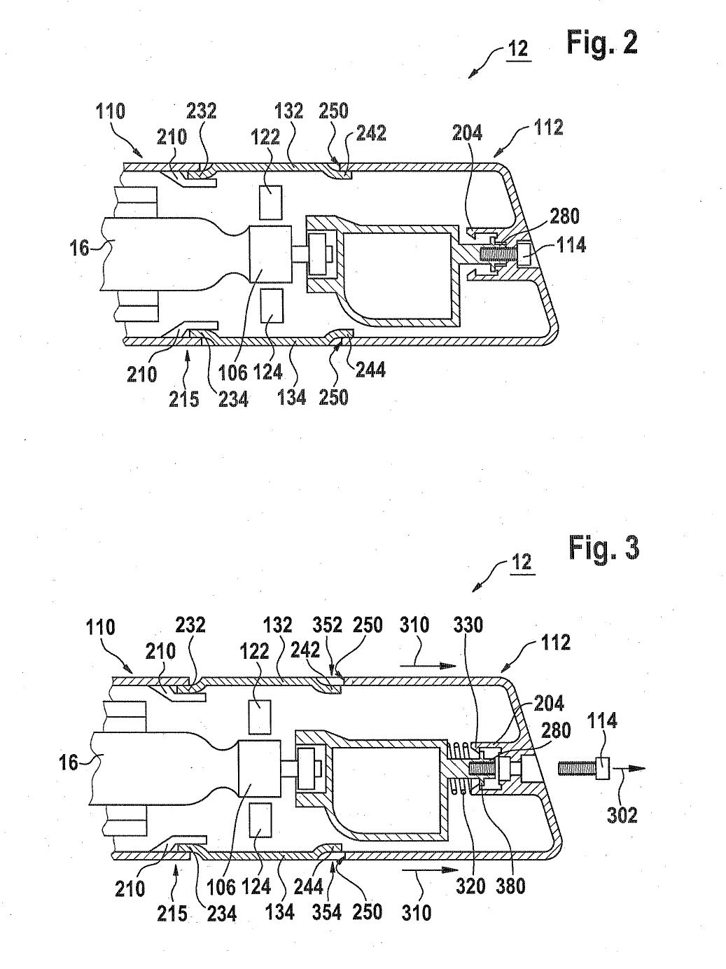

During assembly of the angle grinder 10, the brush covers 132, 134 are placed between the motor housing 110 and the housing cover 112, whereupon the housing cover 112 is fastened to the motor housing 110 with the screw 114. This produces a form-locked engagement between the housing cover 112 and an end region of the brush cover 132 and 134, respectively, oriented toward the housing cover 112 so that the brush covers 132, 134 are fixed in place in an operating position on the motor housing 110, as described below in conjunction with FIG. 2. The housing cover 112 therefore limits the last degree of freedom of the brush covers 132, 134 with regard to a movement of the brush covers 132, 134 relative to the motor housing 110.

It should be noted that the above-described cup-shaped design of the angle grinder 10 is in merely intended for illustrative purposes and that other designs for the angle grinder 10 are also possible. For example, the housing 12 of the angle grinder 10 can be embodied in the form of a shell and can be composed of at least a first and second shell element between which the brush covers 132, 134 are situated. In this case, for example, the first shell element can be affixed to the motor of the angle grinder 10 and the second shell element is detachably connected to the first shell element. Alternatively to this, the motor housing 110 can be embodied in the form of a cup, as shown in FIG. 1, and the housing cover 112 is composed of a first and second shell element.

FIG. 2 shows a detail of the elongated housing 12 of the angle grinder 10 from FIG. 1 in the operating position in which the brush covers 132, 134 are fixed in place between the housing cover 112 and the motor housing 110 in such a way that the housing 12 is closed. The brush covers 132, 134 in this case cover the commutator brushes 122, 124 so that the latter are not accessible from the outside.

According to a preferred embodiment of the invention, the brush covers 132, 134 have guiding and holding elements 232, 234 and 242, 244 that are embodied in the form of tabs. The guiding and holding elements 242, 244 are provided at a first end region of the brush covers 132, 134 and cooperate with the housing cover 112. The guiding and holding elements 232, 234 are provided at a second end region of the brush covers 132, 134 and cooperate with the motor housing 110.

As is clear from FIG. 2, the guiding and holding elements 232, 234 engage with associated engagement elements 210 that are provided in a region 215 of the motor housing 110 oriented toward the housing cover 112. The engaging elements 210 are preferably embodied in the form of grooves or gaps so that the guiding and holding elements 232, 234 can be detachably slid into them.

The connection between the guiding and holding elements 232, 234 and the engaging elements 210 can take place in a frictionless fashion, permitting a simple, force-free removal of the guiding and holding elements 232, 234 from the engaging elements 210. Alternatively to this, the guiding and holding elements 232, 234 can at least partially have a thickness that is greater than the width of the groove of the groove-shaped engaging elements 210 so that a predetermined force is required in order to introduce the guiding and holding elements 232, 234 into the engaging elements 210. This produces a nonpositive, frictional engagement between the guiding and holding elements 232, 234 and the engaging elements 210, which prevents the guiding and holding elements 232, 234 from slipping out of the engaging elements 210 when the housing 12 is opened.

The tab-shaped guiding and holding elements 232, 234 can also be fastened to the engaging elements 210 in pivoting fashion, for example by means of a hinge or an articulation supported in the motor housing 110 in rotary fashion, e.g. a hemispherical swivel, which can be mounted in the motor housing 110 by being clipped into place. Alternatively, the motor housing 110 and the brush covers 132, 134 can be embodied of one piece and be connected to each other by means of a film hinge.

FIG. 2 shows that the housing cover 112 is fastened to the motor housing 110 in the operating position by means of the screw 114; a form-locked engagement is produced between a free end 250 of the housing cover 112 and the guiding and holding element 242, 244, thus fixing the brush covers 132, 134 to the motor housing 110 in the operating position. The housing cover 112 has at least one holding element 204 that engages with a holding device 280 provided on the motor housing 110.

FIG. 3 shows the detail of the elongated housing 12 of the angle grinder 10 from FIG. 2 during the detachment of the detachable connection between the housing cover 112 and the motor housing 110. In this case, after detachment of the screw 114 as indicated by an arrow 302, the housing cover 112 can be at least partially withdrawn from the motor housing 110 in the direction of an arrow 310.

According to the invention, a spring element 320 such as a spiral spring facilitates withdrawal of the housing cover 112 from the motor housing 110. In FIG. 3, this spring element is situated between the motor housing 110 and the holding element 204, e.g. on a corresponding screw boss provided on the motor housing 110, and prestresses the housing cover 112 in the direction toward an end stop, as described below.

According to a preferred embodiment of the invention, a movement of the housing cover 112 relative to the motor housing 110 is limited in such a way that only the form-locked engagement between it and the brush covers 132, 134 is detached to permit an opening and/or removal of the brush covers 132, 134, e.g. in order to replace the commutator brushes 122, 124. To this end, the holding element 204 and the holding device 280 constitute the above-mentioned end stop. For example, the holding element 204 has detent lugs 330 that rest against a collar-shaped stop 380 on the holding device 280 in the position of the end stop.

The limitation of the movement of the housing cover 112 prevents the housing cover from being completely withdrawn from the motor housing 110, for example when replacing the commutator brushes 122, 124; instead, the housing cover can only be withdrawn to the end stop position in which it is possible to access the commutator brushes 122, 124 via the brush covers 132, 134. The housing cover 112 can be completely removed from the motor housing 110, preferably by overcoming a detent engagement.

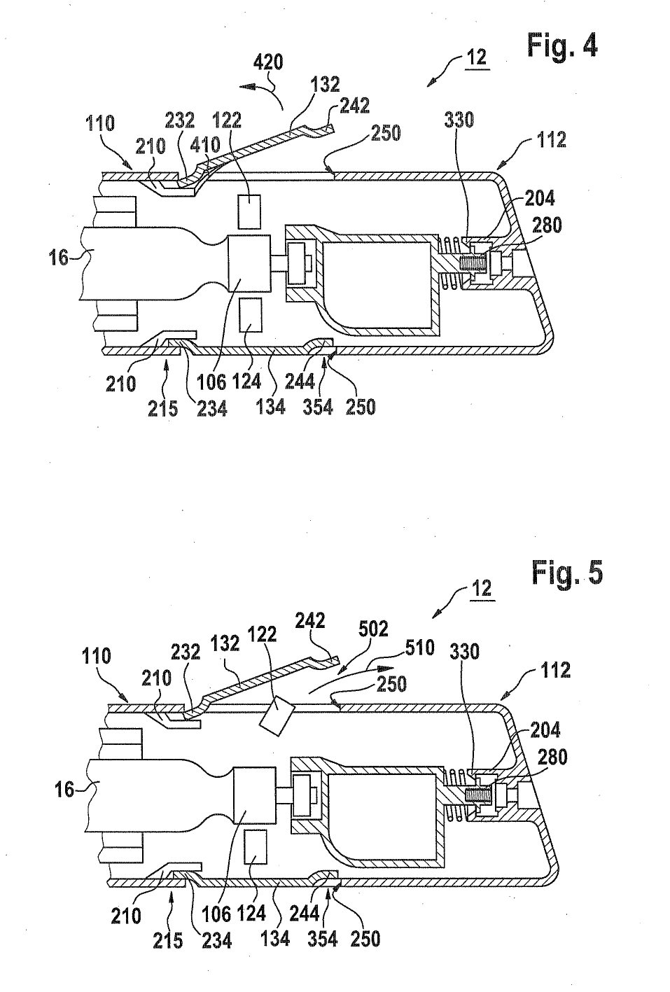

As shown in FIG. 3, a detachment of the detachable connection between the housing cover 112 and the motor housing 110 and consequently a release of the form-locked engagement between the housing cover 112 and the brush covers 132, 134 produces gap-shaped openings 352, 354. These make it possible to open and/or remove the brush covers 132, 134, as described below in conjunction with FIG. 4.

FIG. 4 shows the detail of the elongated housing 12 of the angle grinder 10 from FIG. 3 upon opening and/or removal of the brush covers 132, 134. To simplify the depiction and description, the description below will focus solely on the opening of the brush cover 132 in the direction of an arrow 420. To this end, by means of the gap-shaped opening 352 that is produced when the housing cover 112 is withdrawn (FIG. 2), a suitable tool such as a screwdriver can be slid between the housing cover 112 and the brush cover 132 in order to pry open the brush cover.

According to the invention, the prying open is facilitated by a spring element 410, e.g. a spring or a bending beam-like element, which prestresses the brush cover 132 in the direction toward the maintenance position. Alternative to this, the spring element 410 can be embodied so that the use of a suitable tool is no longer necessary, i.e. the force of the spring element 410 is sufficient to pry open the brush cover 132.

FIG. 5 shows the detail of the elongated housing 12 of the angle grinder 10 from FIG. 4 after the brush cover 132 has been opened. As shown in FIG. 5, when the brush cover 132 is opened, this produces an opening 502 between the brush cover 132 and the housing cover 112 through which the commutator brush 122 can be removed in the direction of an arrow 510.

A replacement of the commutator brush 132 can then take place by carrying out the above-described steps in the reverse sequence, i.e. inserting a new commutator brush, closing the brush cover 132, sliding the housing cover 112 onto the motor housing 110, and fastening the housing cover 112 to the motor housing 110 with the screw 114 (FIG. 2).

1-10. (canceled)

11. An electric power tool with a commutator motor that has a motor shaft, the commutator motor being supported in rotary fashion in a motor housing and being equipped with a commutator that is associated with at least two commutator brushes that are accessible via at least one brush cover provided on the motor housing, wherein a cover element fixes the brush cover to the motor housing in an operating position in which the commutator brushes are covered and the cover element is fastened to the motor housing by means of a detachable connection.

12. The electric power tool as recited in claim 11, wherein a spring element is provided that serves to prestress the brush cover in a direction toward a maintenance position in which it is possible to access the commutator brushes.

13. The electric power tool as recited in claim 11, wherein the cover element is a cup-shaped housing cover that at least partially encompasses the motor housing.

14. The electric power tool as recited in claim 12, wherein the cover element is a cup-shaped housing cover that at least partially encompasses the motor housing.

15. The electric power tool as recited in claim 11, wherein the brush cover is fixed to the motor housing in the operating position by a form-locked engagement between the cover element and a first end region of the brush cover.

16. The electric power tool as recited in claim 12, wherein the brush cover is fixed to the motor housing in the operating position by a form-locked engagement between the cover element and a first end region of the brush cover.

17. The electric power tool as recited in claim 13, wherein the brush cover is fixed to the motor housing in the operating position by a form-locked engagement between the cover element and a first end region of the brush cover.

18. The electric power tool as recited in claim 14, wherein the brush cover is fixed to the motor housing in the operating position by a form-locked engagement between the cover element and a first end region of the brush cover.

19. The electric power tool as recited in claim 15, wherein the motor housing has an engaging element in which a second end region of the brush cover engages in detachable fashion.

20. The electric power tool as recited in claim 16, wherein the motor housing has an engaging element in which a second end region of the brush cover engages in detachable fashion.

21. The electric power tool as recited in claim 17, wherein the motor housing has an engaging element in which a second end region of the brush cover engages in detachable fashion.

22. The electric power tool as recited in claim 18, wherein the motor housing has an engaging element in which a second end region of the brush cover engages in detachable fashion.

23. The electric power tool as recited in claim 15, wherein the brush cover is fastened to the motor housing in pivoting fashion at the second end region.

24. The electric power tool as recited in claim 16, wherein the brush cover is fastened to the motor housing in pivoting fashion at the second end region.

25. The electric power tool as recited in claim 18, wherein the brush cover is fastened to the motor housing in pivoting fashion at the second end region.

26. The electric power tool as recited in claim 11, wherein the cover element has at least one holding element that engages in a holding device provided on the motor housing, and the holding element and the holding device form an end stop, which, upon detachment of the detachable connection between the cover element and motor housing, limits a movement of the cover element intended to release the brush cover.

27. The electric power tool as recited in claim 26, wherein a spring element is provided, which prestresses the cover element in a direction toward the end stop.

28. The electric power tool as recited in claim 26, wherein the holding element has at least one detent lug and the holding device is a collar-shaped stop.

29. The electric power tool as recited in claim 27, wherein the holding element has at least one detent lug and the holding device is a collar-shaped stop.

30. A brush cover for an electric power tool with a commutator motor that has a motor shaft, the commutator motor being supported in rotary fashion in a motor housing and being equipped with a commutator that is associated with at least two commutator brushes and at least one of the commutator brushes is accessible via the brush cover, wherein a cover element is able to affix the brush cover to the motor housing in an operating position in which the at least one commutator brush is covered and the cover element is fastenable to the motor housing by means of a detachable connection.
